(19) United States
(12) Patent Application Publication
(10) Pub. No.: US 2021/0110441 A1
(43) Pub. Date: Apr. 15, 2021

(54) STUDENT LOAN PAYMENT DEVICE

(71) Applicants: Angela Jean Mayer, Spirit Lake, IA (US); Bryan Patrick Harris, Denver, CO (US)

(72) Inventors: Angela Jean Mayer, Spirit Lake, IA (US); Bryan Patrick Harris, Denver, CO (US)

(21) Appl. No.: 17/069,985

(22) Filed: Oct. 14, 2020

Related U.S. Application Data
(60) Provisional application No. 62/915,091, filed on Oct. 15, 2019.

(51) Int. Cl. G06Q 30/02; G06Q 20/10; G06Q 40/02

(52) U.S. Cl. CPC G06Q 30/0279; G06Q 40/02; G06Q 20/102

(57) ABSTRACT

The present invention comprises a system for requesting, receiving, and accounting for contributions related to tuition and student loans. More specifically, the present invention provides a platform through which at least one third party donor may selectively donate to an account associated with a specific student to assist with educational loans or needs of that student. The system includes direct payment by donor to the loan provider.

### FIELD OF INVENTION

According to recent information, over 44 million people in the United States carry student loan debt. The average borrower holds an average $37,000 in student debt. The current student loan debt clock sits at about $1.5 trillion. Yet, for the most part, student loans are not easy to pay; most may only be made with an auto-debit setup or by paying the lender with a debit card over the phone. It is also no simple feat to make a payment to someone else's loan. The present invention provides a platform and an improved computer processor modified to provide the specific functions required to facilitate the system. Specifically, the processor is improved by new financial technology to facilitate contributive actions including providing means to contribute, accept, track, and distribute funds paid in by the loan recipient or by others on his behalf.

### BACKGROUND

There are currently a number of ways for payors to provide payments to service providers or to contribute to various charitable endeavors. Here are a few examples:

Venmo:
Venmo is a free digital wallet that lets the user make and share payments with friends. The user can easily split the bill, cab fare, or pay rent. But it also provides a social layer. For instance, the user can see the user's public transaction history. Users are able to share what they spent their money on and even add emojis to their posts and then can interact with their posts by liking or commenting on them. A user can even remind a contact to send money by specifically requesting it from the contact. Venmo can be used to pay anyone in the US, whether or not they have Venmo, but they will need to join Venmo to claim a payment. As a free-to-use platform, Venmo generates revenue through transaction fees. Many of Venmo's services do not incur transaction fees, including transferring funds between friends through a major debit card or checking account. However, to cover processing costs, Venmo charges a 3% fee for payments by credit card. Venmo is Downloadable for iOS and Android.

PayPal:
PayPal provides a streamlined check out process for individuals and merchants. Users can buy from merchants all over the world via online payment services available in over 200 markets globally with conversion to 25 currencies. A user must create a PayPal account and securely link his bank, credit, and debit card details. A PayPal user can use PayPal to check out online at millions of sites. Users can log into PayPal and checkout securely with an email and password and can add credit, debit, and bank accounts to the user's digital wallet.

Square & Square Cash:
Square Inc. (NYSE: SQ) has rapidly grown into one of the largest payment processing companies in the United States. According to its SEC filings, the company hit $17.9 billion in Gross Payment Volume during Q4 2017. As a part of its growing clout in the fintech industry, Square launched a peer-to-peer (P2P) payment service in 2013 called Square Cash. The Cash App, a P2P platform made by Square, boasts over 7 million active customers. After linking a debit card to the app, individuals or businesses can start sending money where it is needed. One of the key differences between Square Cash and its competitors is that Square Cash moves money in and out of a users' debit card account directly, instead of keeping cash with the service provider. For example, when someone sends money from one PayPal account to another, that money stays inside the recipients' PayPal account until it's withdrawn. With Square Cash, the same transaction will see the money go directly to the receivers' debit card account linked with Square Cash. Square Cash claims that this process is usually completed instantly, though it can take one to two business days for certain banks.
Note that Square Cash only works with debit card accounts, not directly with bank accounts or credit cards. Square makes most of its money from charging businesses fees for the services it provides, though individuals can also incur a 1% fee for expedited deposit services. For businesses that accept Square payments, fees start at 2.75% per swiped transaction and 3.5% plus 15 cents for manually entered transactions. The company also sells additional services to companies at various rates, including a loyalty program, payroll and email marketing among other services. Square allows payments to be made in up to 25 different currencies, though it is unclear if it charges any fees or an additional spread on foreign currency transactions. It is important to note that this fee schedule existed before Square Cash launched and is not a part of the service's website.

Apple Pay:
Apple Pay is a mobile payments service that allows users to make payments in person, in iOS apps, and on the web. It digitizes and can replace a credit or debit card chip and PIN or magnetic stripe transaction at a contactless-capable point-of-sale terminal. Apple Pay may be used with Square if the merchant has the Square contactless and chip reader.

Google Pay & Google Pay Send:
While iPhone users have Apple Pay, Android users have Google Pay. Technically, it was first called Android Pay. Google launched that mobile wallet in September 2015 in the US and May 2016 in the UK In February 2018, Google rolled out an update to Android Pay that changed the name to Google Pay and introduced new functionality that could make the service more ubiquitous. Google Pay is a new mobile payments app that can store credit cards, debit cards, loyalty cards, etc.

Facebook Messenger for Payments:
Facebook is making a new push into the payments space by expanding its partnership with PayPal. Facebook Messenger users can send and request money directly in the app via their PayPal accounts. Facebook Messenger and PayPal initially partnered to enable customers to link their accounts and use PayPal to shop on Messenger. The new development expands the partnership into peer-to-peer payments. The peer-to-peer payments system is available in the U.S. where PayPal has over 2.5 million accounts that are already linked to Facebook. Additionally, PayPal customers can use a customer service chat bot in Messenger allowing them to reset passwords, handle account inquiries and helping with payment issues in the app.

Snapcash:
Snapcash is free and provides means to send money to other individuals. The money safely deposits to the bank account linked to your debit card.

Zelle:
Zelle allows the user to enter a dollar amount to be sent. If the recipient is already enrolled with Zelle the money will be delivered to the recipient's Zelle account via mobile number or bank account number. If the recipient is not a Zelle account holder the recipient will be sent a notification explaining how to receive the money. This works for a sender and recipient that each hold U.S. bank accounts.

Chase QuickPay:
Chase QuickPay is a way to transfer money even if the recipient doesn't have a Chase account. Chase QuickPay is a secure online service that lets users send and receive money electronically from a bank account. Non-Chase customers can use the service by entering their email addresses in the Chase QuickPay tab. Money may be sent to U.S. checking or savings accounts using Chase QuickPay.

Zelle/ClearXchange:
ClearXchange (currently rebranded and Zelle) is a digital payments network, that allows people and businesses to send money to a person with a bank account in the U.S. After registering, any money intended for the recipient is sent directly into his registered bank account. There is no need to set up or fund a separate account.

Clearly, the space where payments can be made and money transferred and deposited is becoming more crowded every day. However, there is not yet to date an improved computer processor that facilitates and comprises means to foster donations to student debt for altruistic reasons and which is dedicated to the repayment of student loans.

### BRIEF DESCRIPTION OF THE DRAWINGS

FIG. 1 Flowchart for set up for student borrower

FIG. 2 Flowchart for donor account set up and donation via bank authorization

FIG. 3 Flowchart for donor account set up and donation via credit card

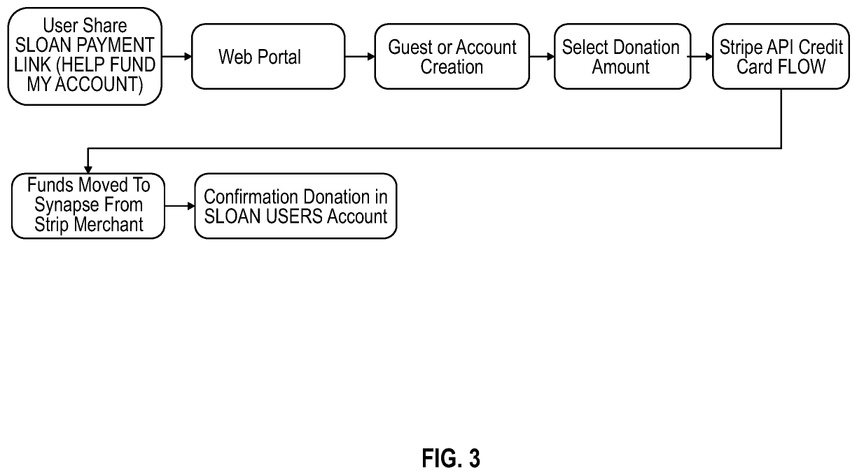

FIG. 4 Overview of payment from account to loan

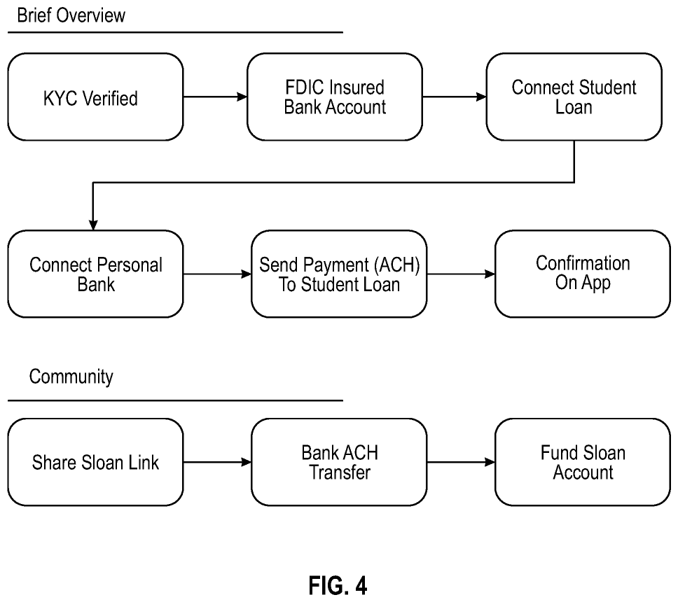

FIG. 5 screenshot of opening screen of the payment facilitation system

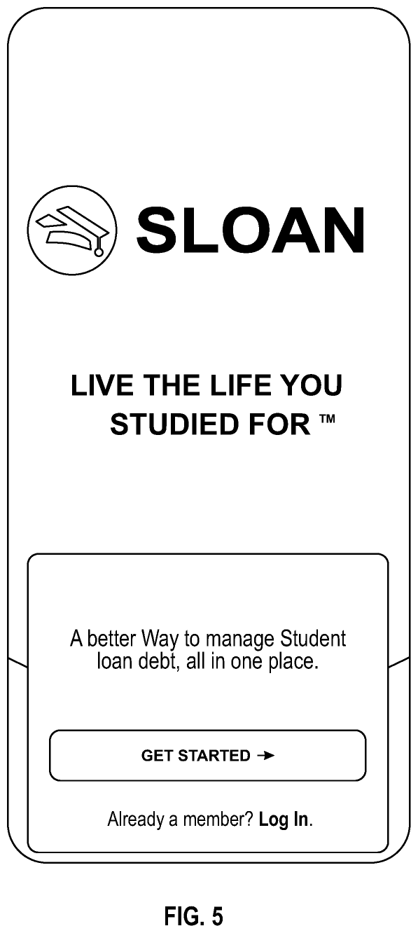

FIG. 6 account creation

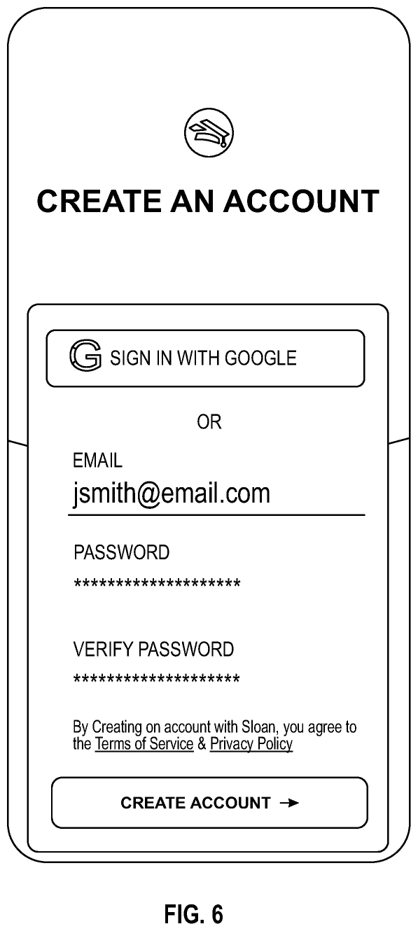

FIG. 7 confirm account creation

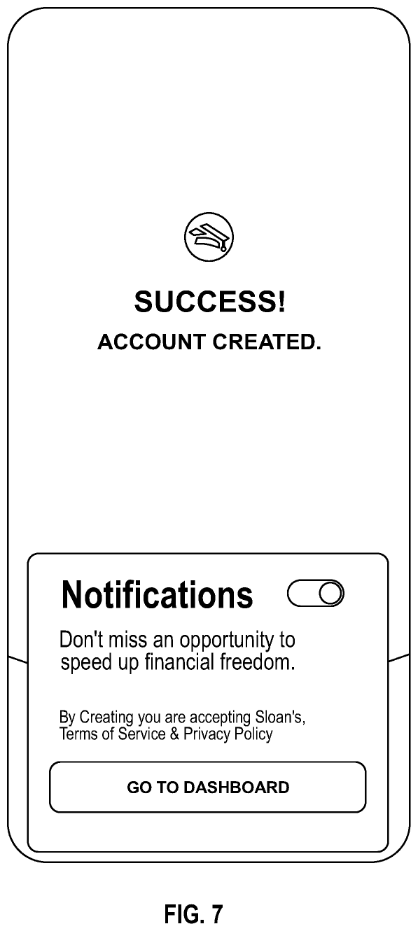

FIG. 8 connecting loans to account

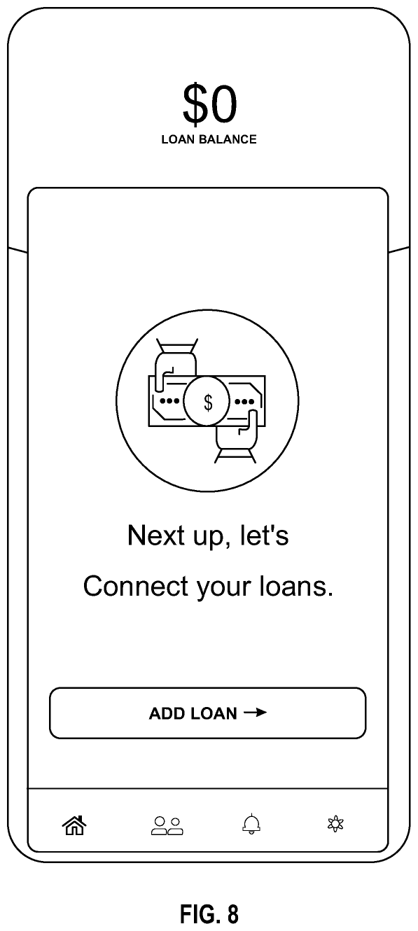

FIG. 9 connecting loan provider information

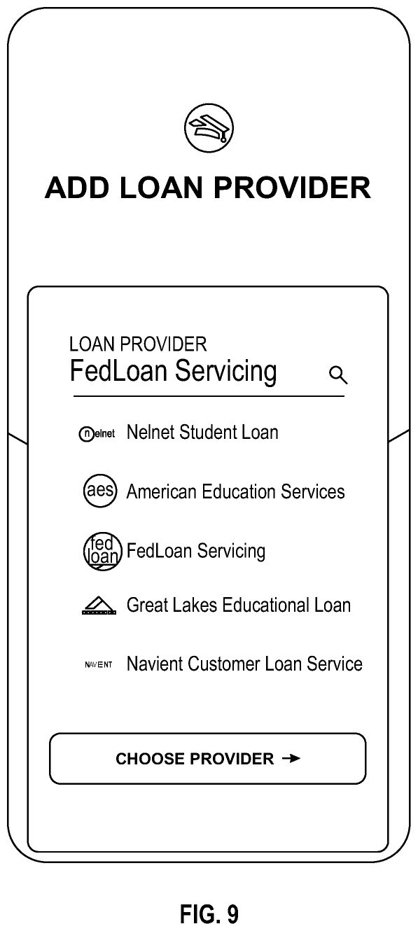

FIG. 10 log in

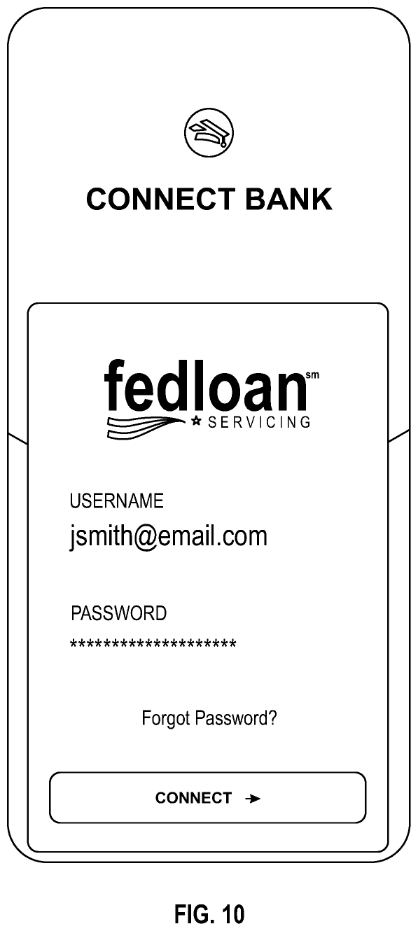

FIG. 11 add loan information

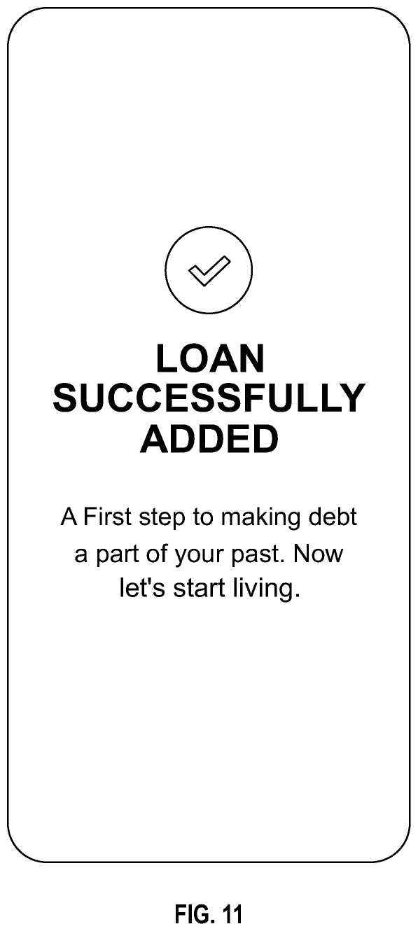

FIG. 12 dashboard showing various functions for managing loans and payments

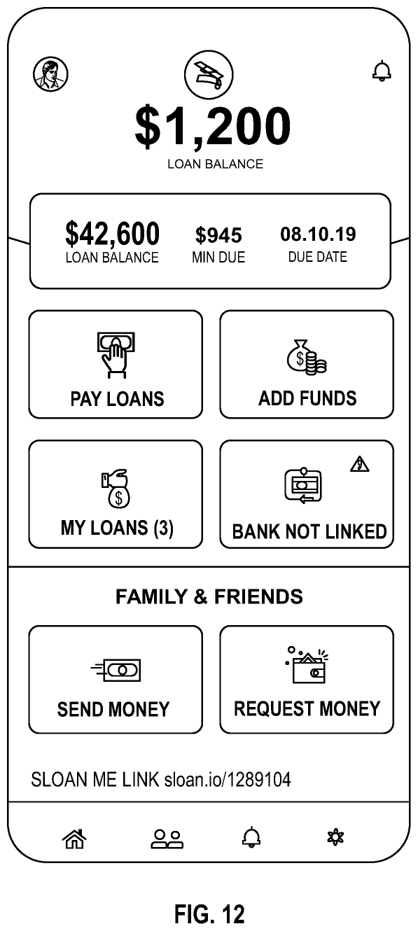

FIG. 13 menu of institutions to which a link may be made

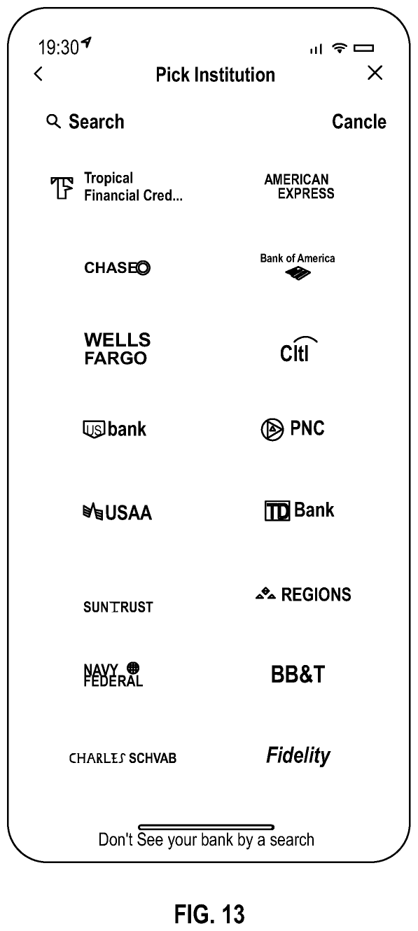

FIG. 14 confirmation of successful bank link

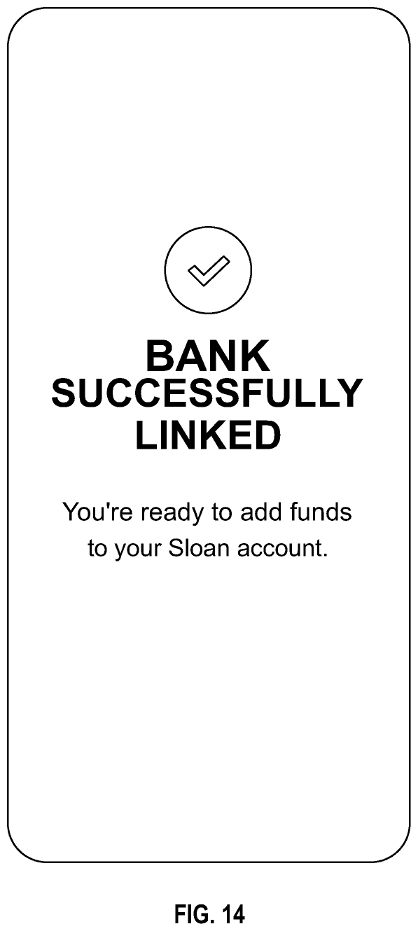

FIG. 15 means to share link with other donors

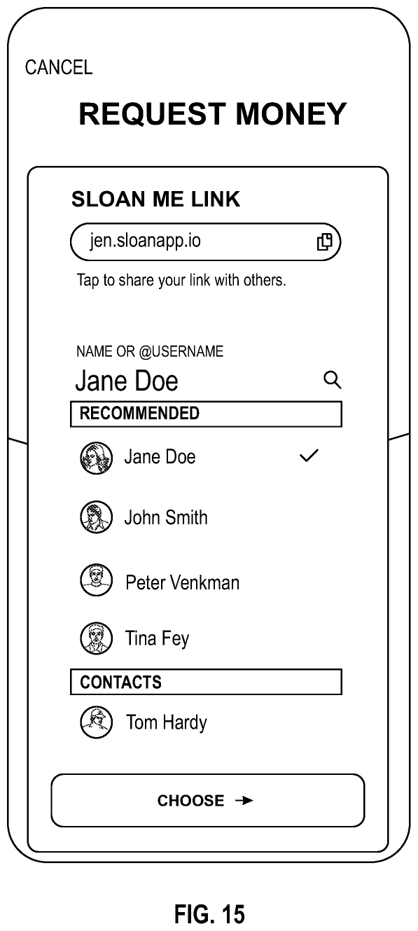

FIG. 16 donation screen to enter amount and recipient

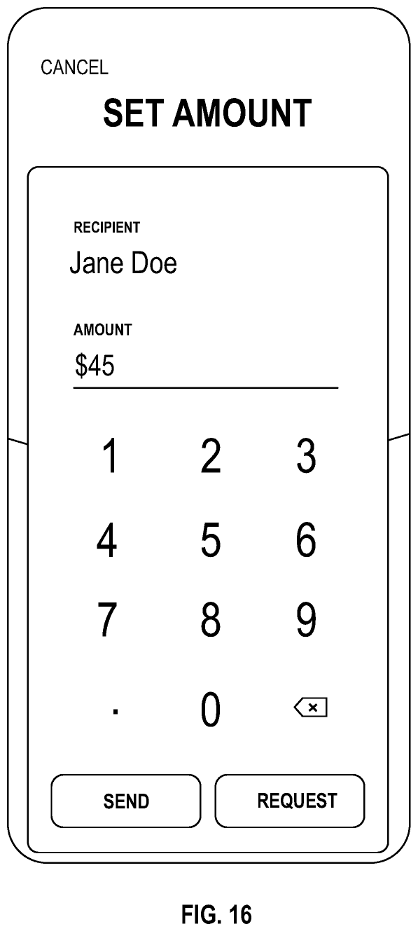

FIG. 17a donation request message

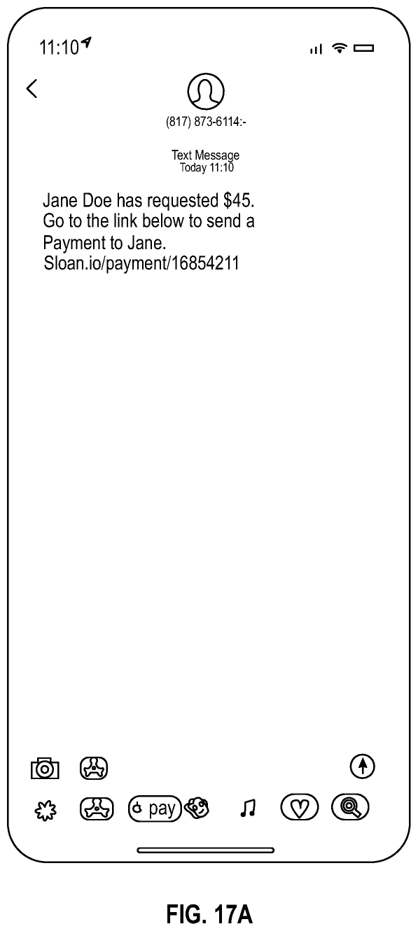

FIG. 17b confirmation of successful request

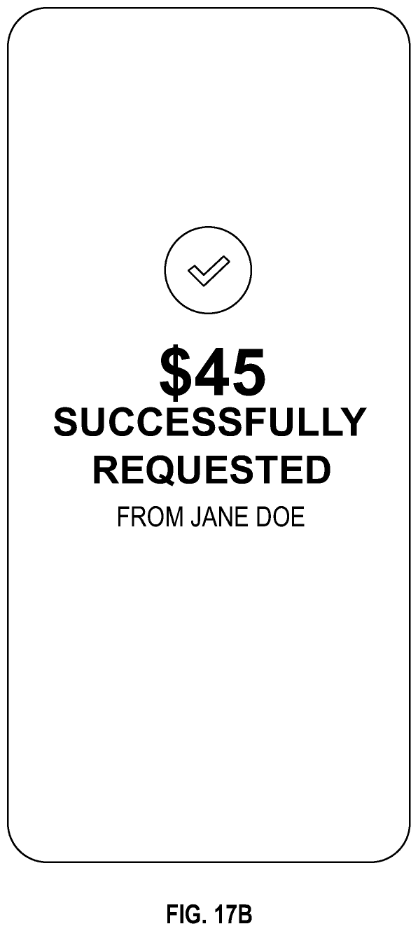

FIG. 18 screen showing amount funded

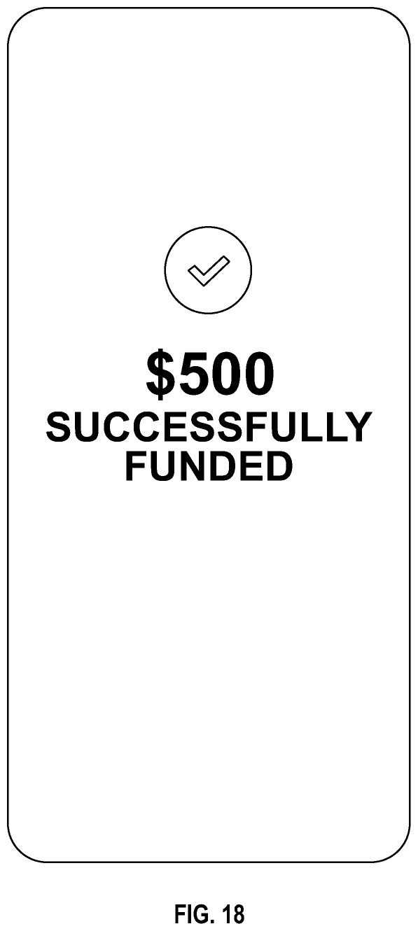

FIG. 19 screen providing critical information and status of all loans

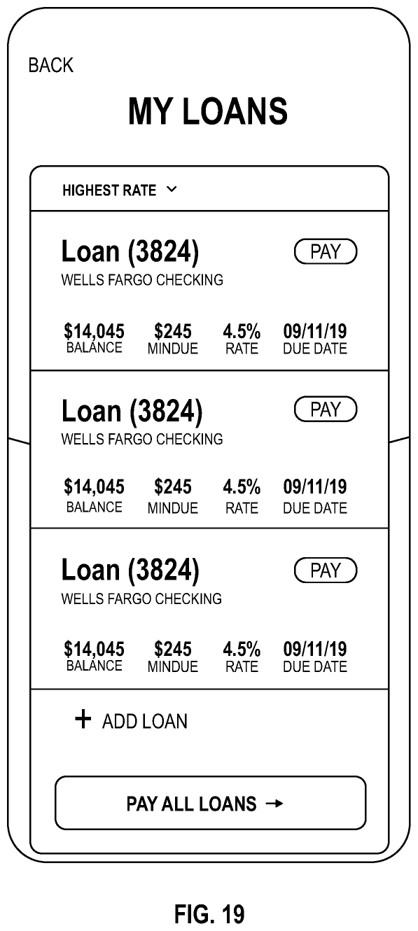

FIG. 20 screen providing functionality to pay selected amount on selected loan

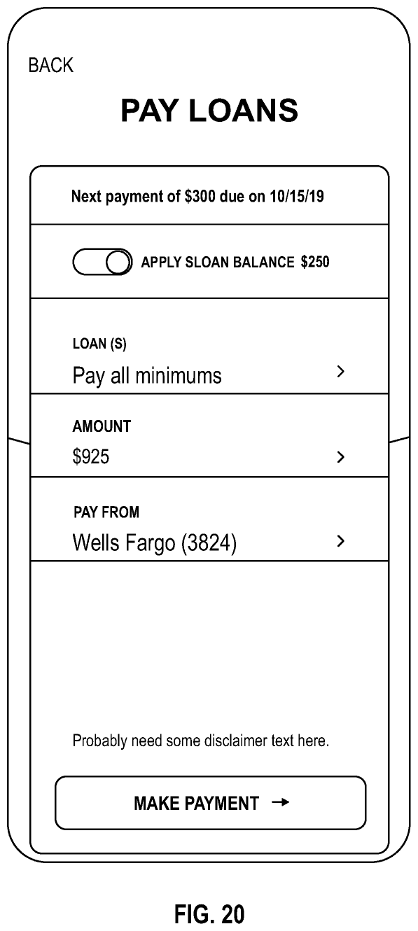

FIG. 21 screen confirming payment made to loan

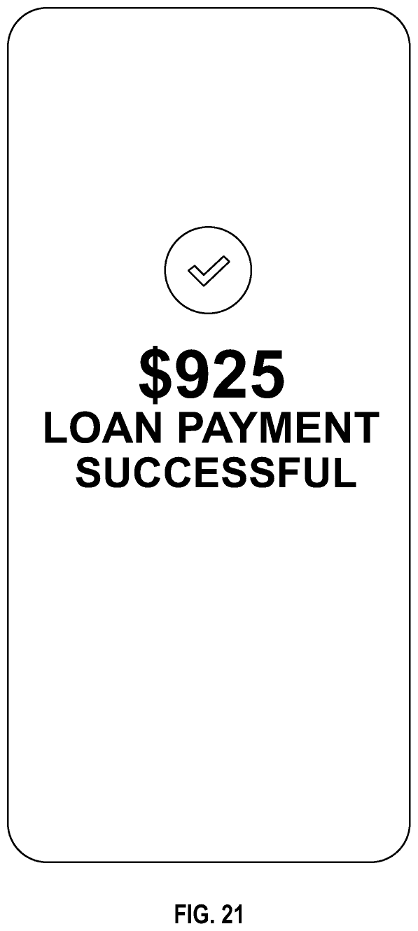

According to sources such as Student LoanHero.com, over 44 million people in the United States carry student loan debt. To put this into perspective, that's 13.7% of the entire population, or everyone between the ages of 25 and 34. The average borrower holds about $30,000 in student debt. The current student loan debt clock sits at about $1.5 trillion and rises by roughly $3,000 every second.

While there are many that owe student debt, the U.S. is becoming more altruistic as a whole. The sentiment and motivation encouraging giving can be credited at least to some extent to the millennial generation; those born near the turn of the century just now breaching adulthood. This generation is passionate about social causes that benefit the greater good, including many charitable organizations. One recent study found the average millennial gives nearly $600 per year to charitable causes in the face of student loan debt, stagnant salaries and a rising cost of living. (citation here).

Millennials tend to be generous with their time, money and influence. They freely use their social media platforms to raise awareness and money for causes important to them. This generation is the most likely to be susceptible and interested in ways that may help them repay, their own debt, and will be more likely to encourage others to act in altruistic ways to help others.

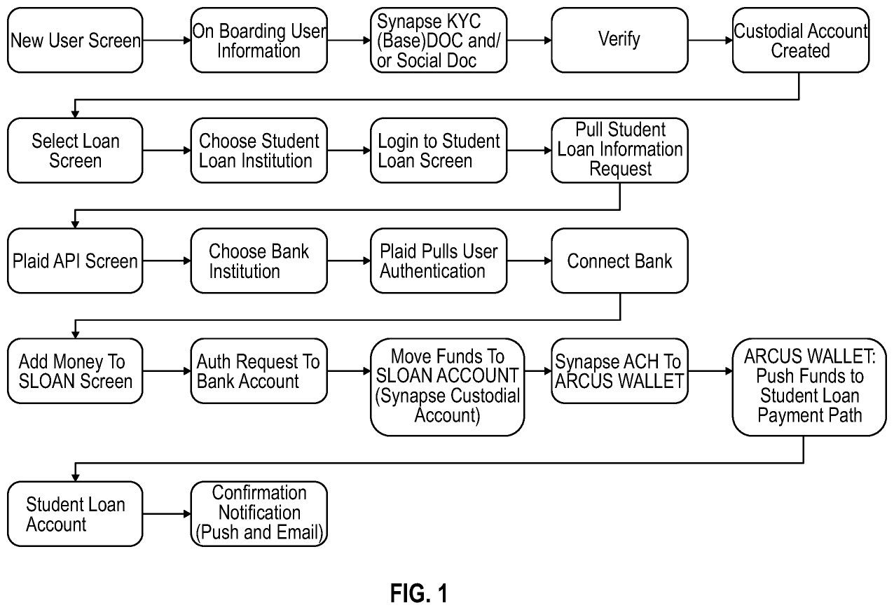

The present invention provides a new type of financial technology that differs from other financial payment facilitation systems. It presents a blend of payment solutions and charitable giving for addressing student loans. Here, the system facilitates charitable contributions to an individual's student loan debt by providing a secure means for contribution to the actual outstanding obligation. The payment facilitation system 10 provides the lender 12 with ample information regarding the status 14 of the student's 15 loan balance 16, and provides the student borrower 15 with means to communicate with a plurality of donors 18, lenders 12, bank or other loan provider 12. In at least one embodiment, the present platform 20 and system 22 provides a secure means for a donor 18 to contribute funds 24 directly to the individual's student loan debt (loan balance) 16 (payments owed on loans). Contributions 18 may be made using debit, credit card. The contributor/donor 18 simply opens the application 10, finds a profile 30 of the Borrower 15 to whom the contributor 18 wishes to contribute, and employs the on-line or telephonic means to deposit an amount 28 toward the student's 15 loan balance 16. The donor 18 may even monitor the progress made by the student 15 and his other donors toward paying off the student's loan balance 16. FIG. 1 provides a schematic showing the major functions of the system 10.

In general, the borrower/student 15 sets up a profile 30 that includes biographical information about the borrower/student that includes the list of post-secondary institutions 34 attended, the loans taken for education 32, and the repayment parameters and terms 36 for those loans. The payment facilitation system 10 will further comprise an account 38 for the borrower 15 which is NOT an account in a financial institution to which the borrower has access; the account 38 is secured in accordance with FDIC requirements, the funds 24 are held in that account 38 for the benefit of the particular borrower/student 15, but the funds 24 are restricted for access by the payment facilitation system 10 to be used for the sole purpose of payment to the lenders 12 for the student loans 32 of that student borrower 15 as are entered and recorded in the system 10 and linked to that student borrower 15. The payment facilitation system 10 will preferably record any funding amount 24 it receives on the student borrower's 15 behalf in a ledger acceptable by the banking industry, and will record the source of funding or lender 12 and the loan 32 to be repaid with these funds 24 (if designated by the source of funding 18, or if prioritized by other criteria), and the date these funds 24 were received. Further, the payment facilitation system 10 notifies the borrower/student 15 if a payment 26 is overdue; this reduces costs to the lender entity 21 for call centers which would otherwise have to make such notification. Finally, the system 10 tracks the amount contributed 28 to each loan 32, the remaining balance 16, and the date the next payment is due 40 for each loan 32.

When a borrower/student 15 fulfills repayment obligations on one of his loans 32, the borrower 15 and the Lender 12 are both notified. A status indicator 14 on the borrower/student's profile 30 may also be re-set to “fulfilled” or “paid” or similar status indicator for that loan 32, while other loan statuses may remain posted.

Another way the system may be employed is along the lines of a more anonymous crowd-funding source. Here, the system 10 may notify its donors 18 PROFILE MEMBERS of a finite number of individual Borrowers 15 in the repayment process, highlighting information about the Borrowers 15 and asking whether the Profile Member wants to donate, say $1, or other minimal amount, to one or more of the highlighted Borrowers 15. This feature is a way to allow members/donors 18 to become involved by giving to someone they don't know but with whom the donor 18 relates or identifies. This one-dollar-at-a time option for a highlighted member may raise enough funds ($1 at a time) to address full indebtedness.

In another embodiment, employers who have agreed to participate in or donate to an employee student loan repayment program 42 can do so directly. As another alternative use, freelance or independent contractors 44 may elect to be paid for services via payment by the contracting company to the contractor's 44 system account 38, toward student loans. SLOAN may also be used to function similarly to a bridal or wedding registry, allowing multiple gift-giving parties to join together to contribute funds for something specific the couple has requested, or, in this case, to their student loan debts. And consider the student athlete with a “fan” base; alumni networks and fans can now contribute to help pay back student loans. Finally, employing the inventive system, gifts may be given toward student loan debt.

### DETAILED DESCRIPTION

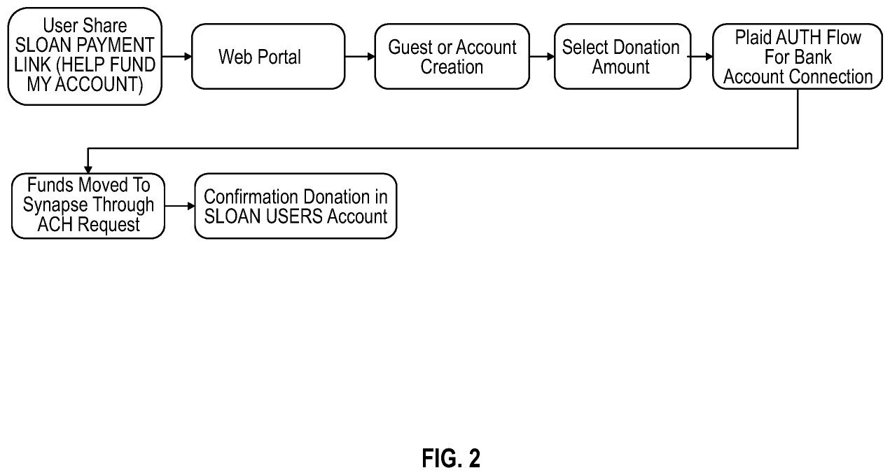

The flow of the system 10 is shown by the flowcharts shown FIGS. 1 and 2. The system 10 is facilitated by the use of one or more computer processors 50 running specialized programs 52 that facilitate and comprise means to receive, track, assign, and disperse donations 24 to a student borrower's 15 loan debt 16. The system may employ a platform 20 which may or may not provide access via portals. The student borrower (hereafter the “Borrower”) 15 creates a profile 17. The Profile 17 is tied directly to a student loan account 38 controlled by the system 10, not to an account owned by the student borrower 15. Profile functionality includes one or more computer processors 50 programmed to track payments owed 26 for each loan 32 of the Borrower, date next payment is due 40 for each said loan, and payments made 27 on each said loan 32 to date, and to figure and present current balances 16 for each loan in real time (to be more fully described herein). The Profile 17 functionality also tracks and presents the timeline and progress for repayment 14, 16 of each loan 32 by its identification code.

At least one lender 12 is associated with each loan 32 along with the Lender's 12 contact and deposit information. The Lender 12 is informed by the system 10, or is provided access to the system 10, or both, for the purpose of tracking Borrower's 17 progress toward pay-off status 14. The system 10 includes a reminder system 60; if a Borrower's 17 account 38 did not make a payment 26 owed to a lender 12, the system 60 will notify the Borrower 15, typically via email or other notification.

The Borrower 15 can make his loan payments 26 directly through the inventive system 60 using a checking account or a credit card to deposit funds 24 to the system 22. The system 22 may be equipped to present to the Borrower 15 timelines and representations of progress including payments owed 26 and payments made 27 toward fulfillment of payback obligations per loan 32 per its terms 25. The system 10 shows the loan status 14 and facilitates payment 27 through one portal, distributing the payments 26 according to minimums owed per month, directly to the loan account 32 and not to the borrower's personal account.

Donation 24 payments from donors 18 can be made on a loan 27 using a debit or credit card by opening the payment system application 10 and finding the profile 17 of the Borrower 15 to whom the donor 18 wishes to contribute. Optionally, the payment 26 may be made via telephone. As donation payments 24 are made, the patron 18 can track their contribution by watching the balances 16 of their selected borrower 15. This donation payment 24 is made without requiring input or action from the Borrower 15 or from the Borrower's bank. The loan balance 16 is then decreased by the amount donated, and shown by the system 10. Importantly, these payments 24, 26 go directly into the loan accounts but not into a personal account owned by the Borrower; once the money is deposited, it must be applied to a loan balance. In some embodiments, the patron may select to which loan his contribution will be applied; in other embodiments, the Borrower can set preferences that might be related to due dates or other factors.

Third party contribution bridges may also or alternatively be employed. For example, Venmo, Pay Pal, Square, Apple Pay, Google Pay, Facebook Messenger, SnapCash, Zelle, Chase Quick Pay, Clear ExChange and Western Union and other similar services may be used. These bridges may be employed to contribute to a SLOAN member account without even opening or downloading the SLOAN application, making contribution simple. These third party bridges are well-known in the art, however, the present invention takes the process a step further by allowing a donor to follow the progress of the Borrower toward meeting his obligations.

Contributions through 4^{th} party payment application bridges come in for various account members from third party contributors. Specifically, each Borrower has or is assigned a unique ID associated with his/her name or account. The account number may also be part of each payment bridge. Specifically, the contribution is sent to the system account, and identified by the unique account number for the Borrower member. The payment may be facilitated through system accounts with Venmo, PayPal, Google Wallet, etc. In turn, the system will payout and disperse the funds in the account from the third party contributors to the intended account number for the Borrower.

Finally, each account member Borrower will pay a low member fee per year; lenders will not pay fees. Transfers between a system account and a lender using the portal will incur a fee based on a percentage of the total transaction, e.g., 0.25%, said fee to be debited from the Borrower's account.

1. An improved computer processor that facilitates and comprises means to foster donations to a student borrower's loan debt said processor providing a financial facilitation system comprising means for a contributor to directly provide funds from the contributor's account to contribute to a specified student loan which loan is not owed by the contributor, said processor comprising means to convert nonstandardized data into a standardized format, storing the standardized data about the borrower's loan and transferring the funds from the contributing user's account to apply to the borrower's loan balance.

2. The improved computer processor of claim 1 providing a secure means for contribution to a borrower's loan debt, said processor further providing a borrower with means to communicate with one or more donors and lenders.

3. The improved processor of claim 1 further comprising a secure means for a donor to contribute funds directly to the borrower's loan debt wherein said funds are never under the control of the borrower.

4. The improved computer processor of claim 1 wherein means for a contributor to directly provide funds comprises a secure means comprising any one or more of debit card, credit card and other electronic payment means.

5. A payment facilitation system comprising an improved computer processor that facilitates and comprises means to foster donations to a borrower's loan debt said processor providing a financial facilitation system comprising means for a contributor to directly provide funds from the contributor's account to contribute to a specified student loan which loan is not owed by the contributor, said processor comprising means to convert nonstandardized data into a standardized format, storing the standardized data about the student's loan and transferring the funds from the contributing user's account to an account holding funds for the benefit of the borrower wherein the borrower cannot directly access the funds in the account, said account secured in accordance with FDIC requirements, the funds restricted to access by the payment facilitation system for the sole purpose of payment to the lenders for the loans of that borrower.

6. A method comprising
a. Storing information in a standardized format about a borrower's loans in at least one of a plurality of network-based, non-transitory storage devices having a collection of loan records stored thereon;
b. Providing remote access to at least one contributing user over a network so any one or more said contributing user can contribute from a contributing user's account a selected amount of funds to a selected borrower's loan balance through a graphical user interface; wherein said contributing user provides information in a non-standardized format dependent on the hardware and software platform used by the contributing user;
c. Converting, by a content server, the non-standardized information into the standardized format;
d. Transferring the amount from the contributing user's account to the borrower's loan balance, reflecting the transfer, and confirming this balance equals a balance provided by the loan record; calculating and generating an update to said borrower's loan balance in real time through said interface; and storing the standardized updated information about the borrower's loan in the collection of student loan records;
e. Generating and sending a transfer confirmation to the contributing user over the computer network in real time.

7. The method of claim 1 wherein the balance equals the previous balance less the amount of the funds contributed by the contributing user.

8. The method of claim 6 wherein the borrower is a student and the loan is a student loan.
